(19) United States
(12) Patent Application Publication
(10) Pub. No.: US 2018/0163372 A1
(43) Pub. Date: Jun. 14, 2018

(54) WORK VEHICLE

(71) Applicant: KOMATSU LTD., Tokyo (JP)

(72) Inventors: Hiroyuki MIZUNO, Uji-shi, Kyoto (JP); Satoru IDE, Ibaraki-shi, Osaka (JP); Takuya WADA, Hirakata-shi, Osaka (JP)

(21) Appl. No.: 15/124,463

(22) PCT Filed: May 19, 2016
(86) PCT No.: PCT/JP2016/064886

§ 371 Date: Sep. 8, 2016

(51) Int. Cl. E02F 9/22; E02F 9/08; F15B 1/26; F15B 21/00; F16L 55/033; G10K 11/16

(52) U.S. Cl. CPC E02F 9/226; E02F 9/0883; G10K 11/161; F15B 21/008; F16L 55/033; F15B 1/26

(57) ABSTRACT

A work vehicle includes a hydraulic fluid tank having a breather valve, and a breather hose attached to the breather valve. The breather hose has a first flowpath joined to the breather valve and a second flowpath and a third flowpath branching off from the first flowpath. The second flowpath has an extension direction that is different from the first flowpath. The second flowpath has an open end, and the third flowpath has a closed end.

### CROSS-REFERENCE TO RELATED APPLICATIONS

This application is a U.S. National stage application of International Application No. PCT/JP2016/064886, filed on May 19, 2016.

### BACKGROUND

### Field of the Invention

The present invention relates to a work vehicle.

### Background Information

Conventionally, a work vehicle is provided with a hydraulic fluid tank for storing hydraulic fluid to be supplied to a work implement.

The oil level of the hydraulic fluid stored in the hydraulic fluid tank rises and falls accompanying the supply and discharge of the hydraulic fluid. A breather valve for ventilating the inside and outside of the hydraulic fluid tank is provided on the hydraulic fluid tank for enabling the smooth supply and discharge of hydraulic fluid.

Moreover, because hydraulic fluid in a mist form is mixed with the air discharged from the breather valve, a breather hose which extends from the breather valve to a desired position is attached to the breather valve so that the area surrounding the breather valve does not become dirty with hydraulic fluid (for example, see Japanese Patent Laid-open No. 2010-60121).

### SUMMARY

However, abnormal noise from the breather hose may be produced when air is discharged from or sucked into the breather valve.

An object of the present invention is to provide a work vehicle that is able to suppress the occurrence of abnormal sounds from the breather hose taking into consideration the above condition.

A work vehicle according to a first aspect of the present invention is provided with a hydraulic fluid tank having a breather valve, and a breather hose attached to the breather valve. The breather hose has a first flowpath joined to the breather valve and a second flowpath and a third flowpath branching off from the first flowpath. The extension direction of the second flowpath is different from the first flowpath. The second flowpath has an open end. The third flowpath has a closed end.

According to the work vehicle as in the first aspect of the present invention, when the air inside the hydraulic fluid tank is discharged from the breather valve, a portion of the air flowing into the branching point from the first flowpath flows into the third flowpath and then flows into the second flowpath after flowing back and forth inside the third flowpath. As a result, abnormal noise occurring in the breather hose can be suppressed. Similarly, when the air is sucked into the hydraulic fluid tank from the breather valve, a portion of the air flowing into the branching point from the second flowpath flows into the third flowpath and then flows into the first flowpath after flowing back and forth inside the third flowpath. As a result, abnormal noise occurring in the breather hose can be suppressed.

The work vehicle according to a second aspect of the present invention is related to the first aspect, and the third flowpath extends upward toward the closed end.

According to the work vehicle as in the second aspect of the present invention, hydraulic fluid in a mist form included in the air exhausted from the breather valve can be suppressed from residing at the closed end of the third flowpath. As a result, the total length of the third flowpath can be prevented from becoming substantially reduced and an interference effect of the air vibration can be maintained over a long period of time.

The work vehicle according to a third aspect of the present invention is related to the first or second aspect, and the second flowpath extends downward toward the open end.

According to the work vehicle as in the third aspect of the present invention, hydraulic fluid in a mist form included in the air discharged from the breather valve can be suppressed from residing near the branching point.

As a result, a smooth air flow inside the breather hose can be maintained over a long period of time.

### Effects of Invention

According to the present invention, a work vehicle can be provided that is able to suppress the occurrence of abnormal noise from the breather hose.

### BRIEF DESCRIPTION OF DRAWINGS

FIG. 1 is a side view of a hydraulic excavator.

FIG. 2 is a side perspective view of the hydraulic excavator.

FIG. 3 is a perspective view of a hydraulic fluid tank.

FIG. 4 is side view of the hydraulic fluid tank.

FIGS. 5(a) to 5(c) are respectively a front view, a side view, and a top view of a branching pipe 23.

FIG. 6 is a schematic view of a configuration of an air flowpath formed inside a breather hose.

FIG. 7 is a schematic view of a configuration of an air flowpath inside a breather hose.

FIG. 8 is a schematic view of a configuration of an air flowpath inside a breather hose.

FIG. 9 is a schematic view of a configuration of an air flowpath inside a breather hose.

FIG. 10 is a schematic view of a configuration of an air flowpath inside a breather hose.

FIG. 11 is a schematic view of a configuration of an air flowpath inside a breather hose.

FIG. 12 is a schematic view of a configuration of an air flowpath inside a breather hose.

### DETAILED DESCRIPTION OF EMBODIMENT(S)

### Configuration of Hydraulic Excavator 100

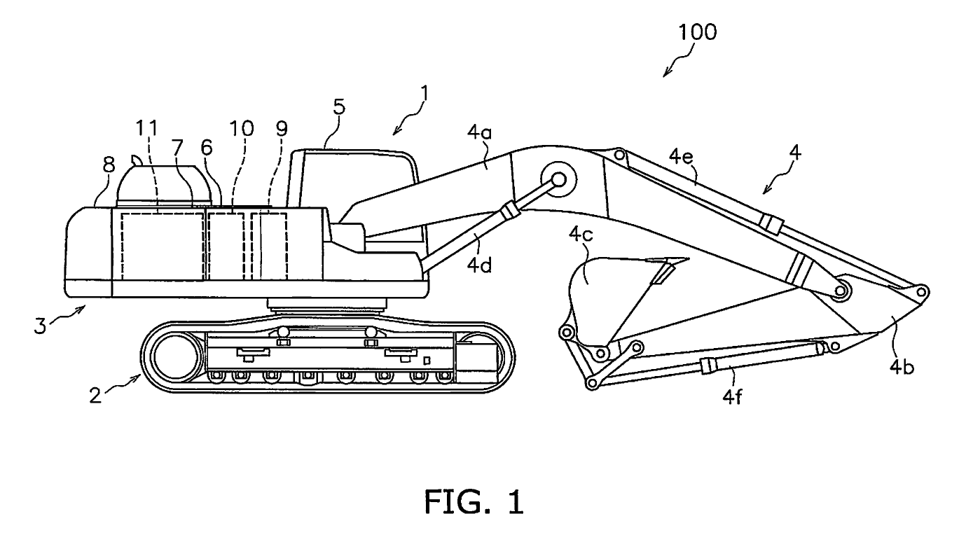

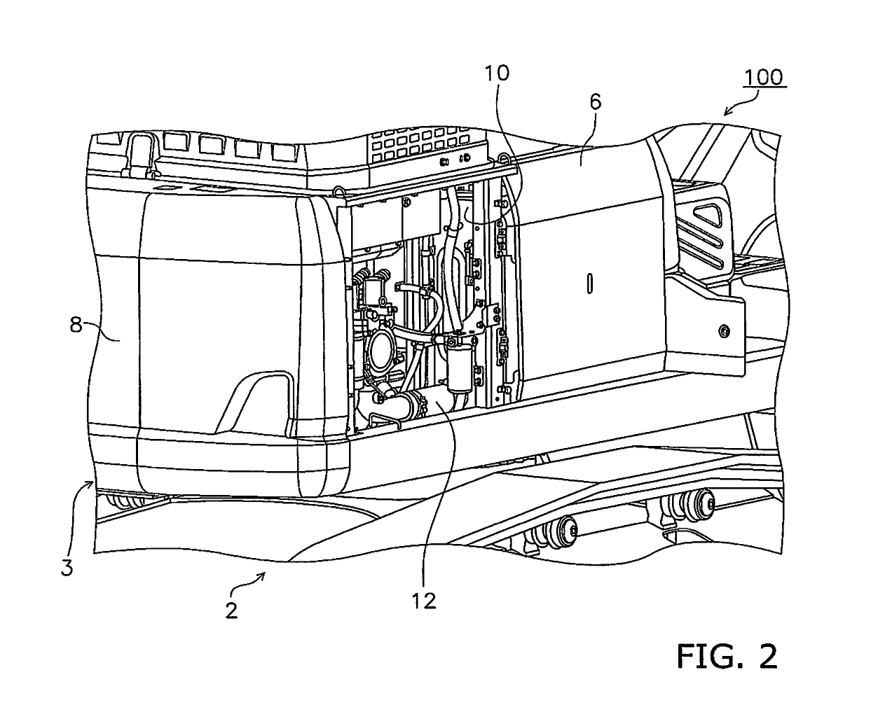

FIG. 1 is a side view of a hydraulic excavator 100. FIG. 2 is a side perspective view of the hydraulic excavator 100. A portion of an engine room cover 70 is removed in FIG. 2.

In the following explanation, “front,” “rear,” “left,” and “right” refer to directions based on looking forward from the operator's seat. “Vehicle width direction” and “left-right direction” have the same meaning.

The hydraulic excavator 100 is an example of a work vehicle according to the present embodiment. The hydraulic excavator 100 is equipped with a vehicle body 1 and a work implement 4.

The vehicle body 1 has an undercarriage 2 and a revolving body 3. The travel device 2 is driven by motive force from an engine 11. The revolving body 3 is mounted on the undercarriage 2. The revolving body 3 is provided in a rotatable manner with respect to the undercarriage 2.

The revolving body 3 has an operating cabin 5, an equipment room cover 6, the engine room cover 7, and a counterweight 8. The operating cabin 5 is disposed on the left side of the proximal end part of the work implement 4.

The equipment room cover 6 is disposed to the rear of the operating cabin 5. An equipment room is formed on the inside of the equipment room cover 6. A fuel tank 9 and a hydraulic fluid tank 10 and the like are housed inside the equipment room. The hydraulic fluid tank 10 stores hydraulic fluid to be supplied to the work implement 4. As illustrated in FIG. 2, a supply pipe 12 for supplying the hydraulic fluid to a hydraulic pump (not illustrated) is connected to the hydraulic fluid tank 10. The configuration of the hydraulic fluid tank 10 is described below.

The engine room cover 7 is connected to the rear of the equipment room cover 6. An engine room is formed on the inside of the engine room cover 7. The engine 11 and the like is contained inside the engine room. The counterweight 8 is disposed to the rear of the engine room 7.

The working equipment 4 is attached to the front part of the revolving superstructure 3. The work implement 4 has a boom 4a, an arm 4b, and a bucket 4c. The proximal end of the boom 4a is connected to the revolving body 3 in a pivotable manner. The boom 4a is driven by a boom cylinder 4d. The proximal end part of the arm 4b is connected to the distal end part of the boom 4a in a pivotable manner. The arm 4b is driven by an arm cylinder 4e. The bucket 4c is coupled to the distal end of the arm 4b in a pivotable manner. The bucket 4c is driven by a bucket cylinder 4f.

The boom cylinder 4d, the arm cylinder 4e, and the bucket cylinder 4f extend and contract due to hydraulic fluid supplied and discharged from the hydraulic fluid tank 10 via a hydraulic pump.

### Configuration of the Hydraulic Fluid Tank 10

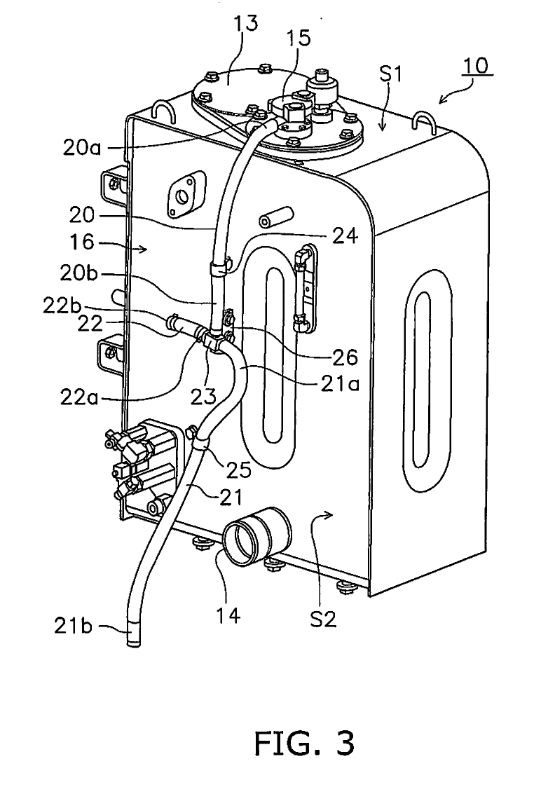

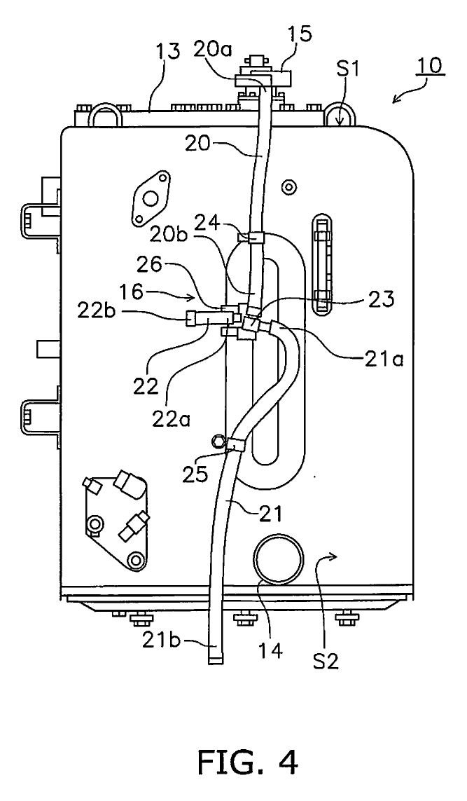

FIG. 3 is a perspective view of the hydraulic fluid tank 10. FIG. 4 is a side view of the hydraulic fluid tank 10.

The hydraulic fluid tank 10 is formed in a substantially rectangular solid shape. The hydraulic fluid tank 10 is formed welding steel plates together. A storage region for storing hydraulic fluid is provided on the inside of the hydraulic fluid tank 10. The oil level of the hydraulic fluid stored in the storage region rises and falls accompanying the supply and discharge of the hydraulic fluid.

The hydraulic fluid tank 10 has an upper surface S1 and a side surface S2. A filtration unit 13 is attached to the upper surface S1 of the hydraulic fluid tank 10. The filtration unit 13 is inserted into the inside of the hydraulic fluid tank 10 from the upper surface S1. The filtration unit 13 filters wear debris and the like mixed in the hydraulic fluid returning to the hydraulic fluid tank 10. A connecting pipe 14 is connected to a lower end part of the side surface S2 of the hydraulic fluid tank 10. The supply pipe 12 (see FIG. 2) is connected to the connecting pipe 14.

A breather valve 15 is attached to the filtration unit 13. The breather valve 15 ventilates the inside and the outside of the hydraulic fluid tank 10. The breather valve 15 adjusts the air volume inside the storage region in response to the fluctuation of the oil level of the hydraulic fluid. If the oil level of the hydraulic fluid rises, air is exhausted from the hydraulic fluid tank 10 through the breather valve 15. If the liquid level of the hydraulic fluid falls, air is sucked into the hydraulic fluid tank 10 through the breather valve 15. A filter may be built into the breather valve 15.

A breather hose 16 is attached to the breather valve 15. Air that is discharged from or sucked into the breather valve 15 flows through the breather hose 16. Hydraulic fluid in a mist form may be mixed with the air exhausted from the breather valve 15. Therefore, the breather hose 16 is extended to a downward of the revolving body 3 so that the area surrounding the breather valve 15 does not become dirty due to the hydraulic fluid.

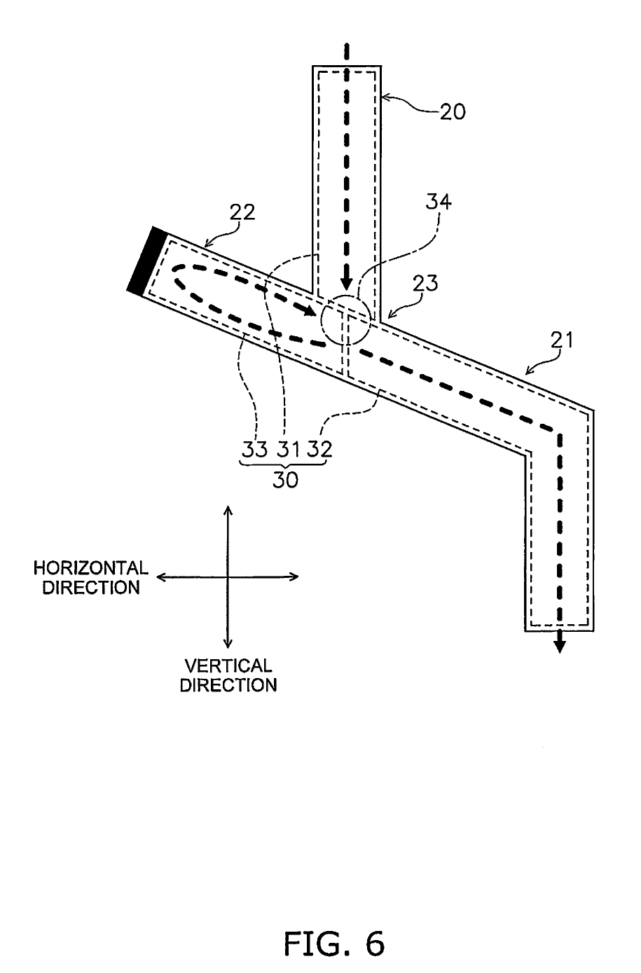

The breather hose 16 has a connecting hose 20, an open hose 21, a closed hose 22, and a branching pipe 23. An air flowpath 30 (see FIG. 6) is formed inside the breather hose 16.

The connecting hose 20 is formed in a tubular shape. The connecting hose 20 connects the breather valve 15 with the branching pipe 23. A first end part 20a of the connecting hose 20 is connected to the breather valve 15. A second end part 20b of the connecting hose 20 is connected to the branching pipe 23. The connecting hose 20 may be configured with a rubber material and the like, but is not limited in this way.

The connecting hose 20 in the present embodiment is disposed along the side surface S2 from the upper surface S1 of the hydraulic fluid tank 10 and the entire length is disposed in the vertical direction. However, the shape and disposition of the connecting hose 20 may be changed as appropriate. The connecting hose 20 is fixed to the side surface S2 of the hydraulic fluid tank 10 with a fixing tool 24.

The open hose 21 is formed in a tubular shape. A first end part 21a of the open hose 21 is connected to the branching pipe 23. A second end part 21b of the open hose 21 is disposed in a desired position. The second end part 21b of the open hose 21 is an open end. An opening of the second end part 21b of the open hose 21 is opened and is not blocked. Air discharged from the breather valve 15 is discharged from the second end part 21b of the open hose 21. Air sucked in from the breather valve 15 is brought in from the second end part 21b of the open hose 21. The open hose 21 may be configured with a rubber material and the like, but is not limited in this way.

The open hose 21 in the present embodiment extends laterally and downward from the branching pipe 23 and the entire length extends in the vertical direction. However, the shape and disposition of the open hose 21 may be changed as appropriate. The open hose 21 is fixed to the side surface S2 of the hydraulic fluid tank 10 with a fixing tool 25.

The closed hose 22 is formed in a tubular shape. A first end part 22a of the closed hose 22 is connected to the branching pipe 23. A second end part 22b of the closed hose 22 is disposed in a desired position. The second end part 22b of the closed hose 22 is a closed end. An opening of the second end part 22b of the closed hose 22 is blocked and is not opened. The opening of the second connecting part 22b of the closed hose 22 may be blocked with a rubber plug and the like. However, a hose with no opening formed at the second end part 22b may be used as the closed hose 22.

As described below, a portion of the air discharged from the breather valve 15 flows back and forth inside the closed hose 22. Similarly, a portion of the air drawn in from the second end part 21b of the open hose 21 flows back and forth inside the closed hose 22. The closed hose 22 may be configured with a rubber material and the like, but is not limited in this way.

The closed hose 22 in the present embodiment extends laterally and upwards from the branching pipe. However, the shape and disposition of the closed hose 22 may be changed as appropriate. The entire length of the closed hose 22 is short and thus the closed hose 22 is not fixed in the present embodiment.

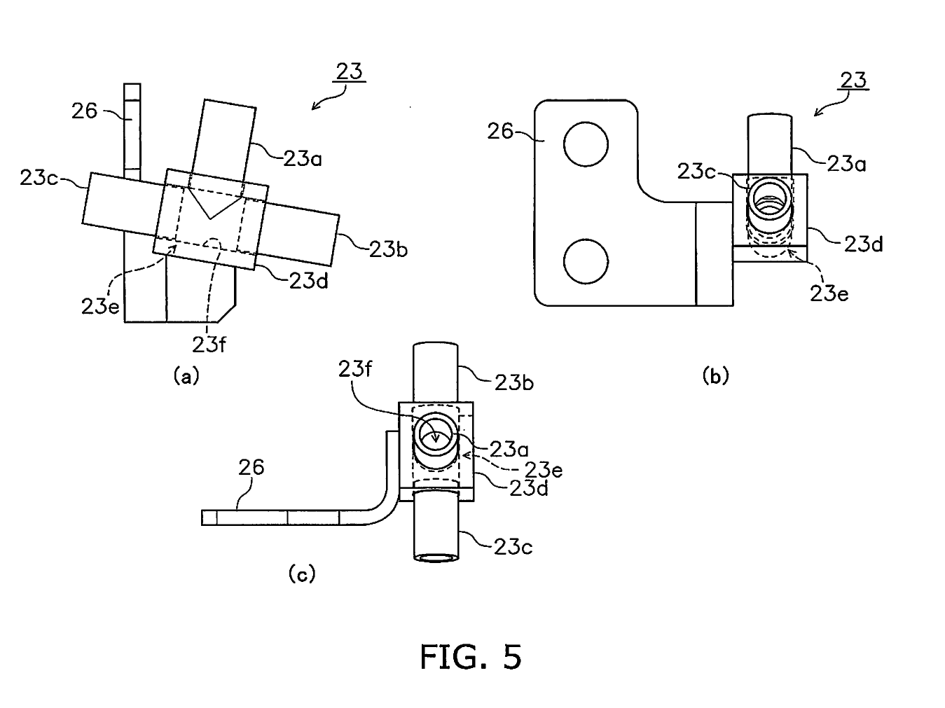

The branching pipe 23 is connected to the connecting hose 20, the open hose 21, and the closed hose 22. FIG. 5(a) is a front view of the branching pipe 23. FIG. 5(b) is a side view of the branching pipe 23. FIG. 5(c) is a top view of the branching pipe 23. The branching pipe 23 has a first connecting part 23a, a second connecting part 23b, a third connecting part 23c, and a branching block 23d.

The first connecting part 23a, the second connecting part 23b, and the third connecting part 23c are formed in hollow tubular shapes. The first connecting part 23a is connected to the second end part 20b of the connecting hose 20. The second connecting part 23b is connected to the first end part 21a of the open hose 21. The third connecting part 23c is connected to the first connecting part 22a of the closed hose 22.

The branching block 23d supports the first connecting part 23a, the second connecting part 23b, and the third connecting part 23c. A three-way branching flowpath 23e is formed inside the branching block 23d. The three-way branching flowpath 23e is joined with the first connecting part 23a, the second connecting part 23b, and the third connecting part 23c. The branching block 23d is fixed to the side surface S2 of the hydraulic fluid tank 10 with an L-shaped bracket 26.

Air exhausted from the breather valve 15 flows from the first connecting part 23a into the three-way branching flowpath 23e and then hits an inner surface 23f of the branching block 23, and is divided into two directions: toward the second connecting part 23b and toward the third connecting part 23c. The air flowing through the third connecting part 23c flows back and forth inside the closed hose 22 and then merges with the air flowing through the second connecting part 23b.

In contrast, air taken in from the second end part 21b of the open hose 21 flows from the second connecting part 23b to the three-way branching flowpath 23e and then is divided into two directions: toward the first connecting part 23a and toward third connecting part 23c. The air flowing through the third connecting part 23c flows back and forth inside the closed hose 22 and then merges with the air flowing through the first connecting part 23a.

### Configuration of the Air Flowpath 30

FIG. 6 is a schematic view of a configuration of the air flowpath 30 formed inside the breather hose 16.

The air flowpath 30 has a first flowpath 31, a second path 32, and a third flowpath 33. The first flowpath 31 is joined to the breather valve 15. The first flowpath 31 branches into the second flowpath 32 and the third flowpath 33. The second flowpath 32 and the third flowpath 33 are joined from the first flowpath 31.

The first flowpath 31 is mainly formed inside the connecting hose 20. The second flowpath 32 is mainly formed inside the open hose 21. The third flowpath 33 is mainly formed inside the closed hose 22. The first flowpath 31, the second flowpath 32, and the third flowpath 33 communicate with each other at a branching point 34. The branching point 34 is formed inside the branching pipe 23. While the extension direction of the first flowpath 31 in the present embodiment is in the vertical direction, the present embodiment is not limited in this way.

The extension direction of the second flowpath 32 is different from the extension direction of the first flowpath 31. The second flowpath 32 is joined to the first flowpath 31 at the branching point 34 so as to disturb the air flow flowing in from the first flowpath 31. The tip of the second flowpath 32 is an open end. The second flowpath 32 is inclined downward from the branching point 34 toward the open end. The extension direction of the second flowpath 32 in the present embodiment is in a direction inclined with respect to the vertical direction, but the present embodiment is not limited in this way. The extension direction of the second flowpath 32 may be different from the extension direction of the first flowpath 31.

The extension direction of the third flowpath 33 is different from the extension direction of the first flowpath 31. The third flowpath 33 is provided at the branching point 34 so as to disturb the air flow flowing in from the first flowpath 31. The tip of the third flowpath 33 is a closed end. The third flowpath 33 is inclined upward from the branching point 34 toward the closed end. The third flowpath 33 in the present embodiment is not inclined with respect to the second flowpath 32 and is joined in a straight line with the second flowpath 32. The extension direction of the third flowpath 33 in the present embodiment is in a direction inclined with respect to the vertical direction and is the same as the extension direction of the second flowpath 32, but the present embodiment is not limited in this way. The extension direction of the third flowpath 33 may be different from the extension direction of the first flowpath 31.

### Characteristics

(1) The breather hose 16 has formed therein the first flowpath 31 joined with the breather valve 15 and the second flowpath 32 and the third flowpath 33 branching off from the first flowpath 31. The extension direction of the second flowpath 32 is different from the extension direction of the first flowpath 31. The second flowpath 32 has the open end and the third flowpath 33 has the closed end.

Therefore, when the air inside the hydraulic fluid tank is discharged from the breather valve 15, a portion of the air flowing into the branching point 34 from the first flowpath 31 flows into the third flowpath 33 and then flows into the second flowpath 32 after flowing back and forth inside the third flowpath 33. As a result, abnormal noise occurring in the breather hose 16 can be suppressed. It is thought that this is because the vibration of the air having a phase delay due to flowing back and forth inside the third flowpath 33 combines with the vibration of the air flowing from the first flowpath 31 into the second flowpath 32, whereby the vibration of the air flowing from the first flowpath 31 into the second flowpath 32 is weakened due to the interference with the vibration of the air flowing back and forth inside the third flowpath 33.

Similarly, when the air is sucked into the hydraulic fluid tank 10 from the breather valve 15, a portion of the air flowing into the branching point 34 from the second flowpath 32 flows into the third flowpath 33 and then flows into the first flowpath 31 after flowing back and forth inside the third flowpath 33. As a result, abnormal noise occurring in the breather hose 16 can be suppressed. It is thought that this is because the vibration of the air having a phase delay due to flowing back and forth inside the third flowpath 33 combines with the vibration of the air flowing from the second flowpath 32 into the first flowpath 31, whereby the vibration of the air flowing from the second flowpath 32 into the first flowpath 31 is weakened due to the interference with the vibration of the air flowing back and forth inside the third flowpath 33.

(2) The third flowpath 33 is inclined upward from the branching point 34 toward the closed end. Therefore, the hydraulic fluid in a mist form included in the air discharged from the breather valve 15 can be suppressed from residing at the closed end of the third flowpath 33. As a result, the total length of the third flowpath 33 can be prevented from becoming substantially reduced due to the residing hydraulic fluid and the abovementioned interference effect of the air vibration can be maintained over a long period of time.

(3) The second flowpath 32 is inclined downward from the branching point 34 toward the open end. As a result, the hydraulic fluid in a mist form included in the air exhausted from the breather valve 15 can be suppressed from residing near the branching point 34. As a result, a smooth air flow inside the breather hose 16 can be maintained over a long period of time.

### Other Embodiments

While the first flowpath 31 extends downward toward the branching point 34, the second flowpath 32 is inclined downward from the branching point 34 toward the open end, and the third flowpath 33 is inclined upward from the branching point 34 toward the closed end in the above embodiment, the above embodiment is not limited in this way from the point of view of suppressing abnormal noise. So long as the extension direction of the second flowpath 32 is different from the extension direction of the first flowpath 31, the shapes and dispositions of the first flowpath 31, the second flowpath 32, and the third flowpath 33 may be changed as appropriate.

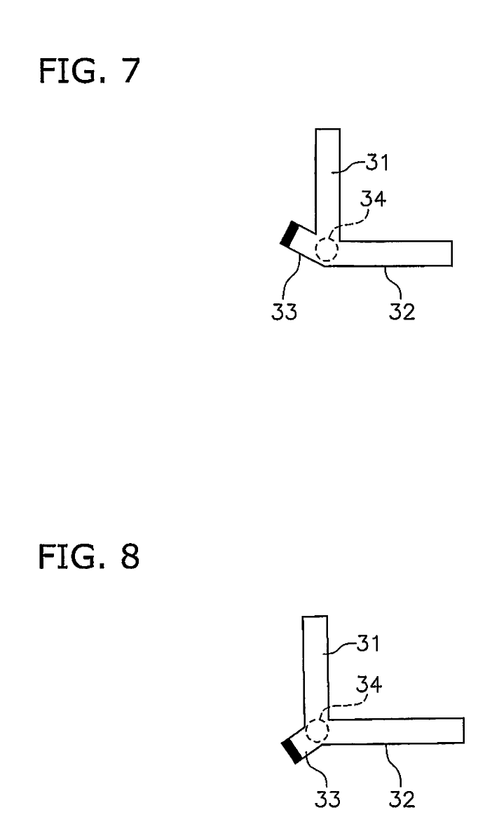

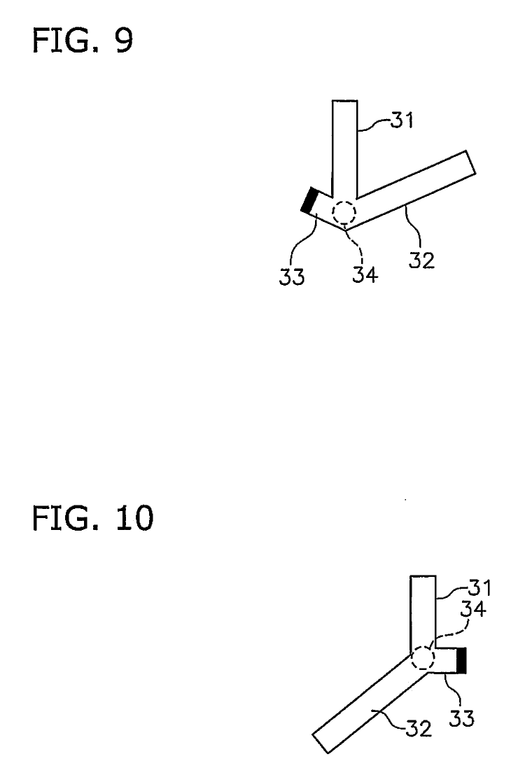

For example, the second flowpath 32 may extend horizontally from the branching point 34 as illustrated in FIGS. 7 and 8, or the second flowpath 32 may extend upward from the branching point 34 as illustrated in FIG. 9.

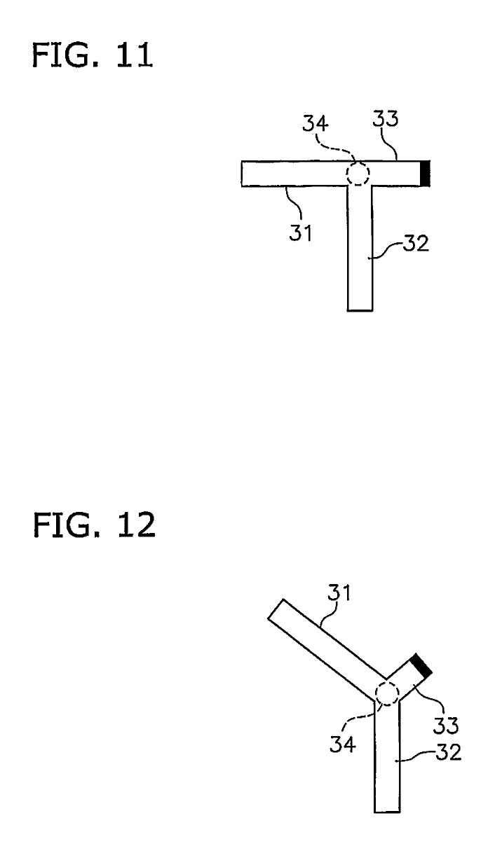

Moreover, the third flowpath 33 may extend downward from the branching point 34 as illustrated in FIG. 8, or the third flowpath 33 may extend horizontally from the branching point 34 as illustrated in FIGS. 10 and 11.

Moreover, the first flowpath 31 may extend diagonally toward the branching point 34 as illustrated in FIG. 12.

While the total length of the closed hose 22 that forms the third flowpath 33 is short and thus is not fixed in the above embodiment, the closed hose 22 may be fixed to the side surface S2 of the hydraulic fluid tank 10, or may be fixed to the connecting hose 20.

While a case of the breather hose according to the present invention used in a hydraulic excavator has been discussed in the above embodiment, the present invention is not limited in this way. The breather hose according to the present invention may be used in a work vehicle provided with a work implement such as a bulldozer, a wheel loader, or a motor grader and the like.

1. A work vehicle, comprising:
a hydraulic fluid tank having a breather valve; and
a breather hose attached to the breather valve,
the breather hose having a first flowpath joined to the breather valve and a second flowpath and a third flowpath branching off from the first flowpath,
the second flowpath having an extension direction that is different from the first flowpath,
the second flowpath having an open end, and
the third flowpath having a closed end.

2. The work vehicle according to claim 1, wherein the third flowpath extends upward toward the closed end.

3. The work vehicle according to claim 1, wherein:
the second flowpath extends downward toward the open end.

4. The work vehicle according to claim 2, wherein:
the second flowpath extends downward toward the open end.
